(19) United States
(12) Patent Application Publication
(10) Pub. No.: US 2024/0094950 A1
(43) Pub. Date: Mar. 21, 2024

(54) BLOCK LAYER PERSISTENT MEMORY BUFFER

(71) Applicant: Western Digital Technologies, Inc., San Jose, CA (US)

(72) Inventors: Shay BENISTY, Beer Sheva (IL); Amir SEGEV, Meiter (IL); Judah Gamliel HAHN, Ofra (IL)

(73) Assignee: Western Digital Technologies, Inc., San Jose, CA (US)

(21) Appl. No.: 17/946,541

(22) Filed: Sep. 16, 2022

(51) Int. Cl. G06F 3/06

(52) U.S. Cl. CPC G06F 3/0659; G06F 3/0611; G06F 3/0679

(57) ABSTRACT

The present disclosure generally relates to improved access to the DRAM using namespace mapping. The PMR address range is mapped to LBA address space. Mapping the PMR address range in LBA address space allows the host to access the PMR indirectly using NVMe commands. The host device may hold in the namespace the most frequently accessed data and obtain highest performance and low latency. Implementation of the Power Loss Protection (PLP) feature over the PMR makes the system prefer storing the data in PMR rather in host memory. All internal SRAMs (e.g. Transfer RAMs, XOR RAMs, etc.) may be mapped in the LBA address space so the host device can access mainly for debug purposes. Some internal flops that hold important data are mapped in the LBA address space as well.

### BACKGROUND OF THE DISCLOSURE

### Field of the Disclosure

Embodiments of the present disclosure generally relate to improving access to DRAM using namespace mapping.

### Description of the Related Art

The Persistent Memory Region (PMR) is an optional region of general-purpose PCI Express (PCIe) read/write persistent memory that may be used for a variety of purposes. PMR can be mapped to the address space on the PCIe bus and can be accessed by hosts and the device controller.

The main feature of PMR is that the data written to PMR is also retained after the power outage of the (power cycle), the controller resets and the PMR enables/disables switching. In other words, this feature enables SSD to provide another non-volatile storage area in addition to the storage area accessed through the logical block address (LBA), and this storage area is assumed to be accessed by memory access rather than block access.

PMR requires high performance. In general, PMR space can provide a memory-level read and write speed, a storage area where data will not be lost after a power outage. PMR has the characteristics of non-volatile, low latency, and byte addressing, which makes data management more flexible. PMR is ideal for environments that require frequent access to complex data sets, as well as sensitive environments where downtime is caused by power failure or system crash.

Non-volatile memory express (NVMe) has been actively exploring other uses of DRAM in solid-state drives, and PMR is a potential application. Most enterprise SSDs have a certain amount of DRAM memory or cache buffer, SSDs that store FTL entries that can map logical addresses and flash physical addresses through the FTL entries. In addition, NVMe protocol defines the feature of controller memory buffer (CMB) in the controller, which aims to make the DRAM space in part of the SSD accessible directly through the PCI address space. The feature allows the submission queue (SQ) and completion queue (CQ) needed for NVMe to transmit input/output (IO) commands to be directly stored in the DRAM memory of the SSD instead of the host memory, which can reduce the delay of command interaction. In addition, the feature can eliminate the unnecessary replication operation in the DMW transmission between SSD end-to-end in the case of NVMe over Fabrics, and make the transmitted data bypass the DRAM of the host completely.

In the previous approach CMB/PMR is mapped directly in the PCIe memory region and the host device can access the CMB/PMR directly by issuing memory read/write transactions over PCIe. The access latency is less than that of NAND flash memory and is close to that of DRAM. Compared with NAND flash memory, the throughput is greatly increased. Bytes addressable, real-time access to data, allowing ultra-fast access to large datasets are present. The data remains in memory after a power outage (just like using flash memory). The feature complicates the device controller and makes the device controller more expensive since the inbound path (Host→Device) should be high-performance as the outbound path (Device→Host). Therefore, there is a need for PMR memory without having the complexity of byte access and direct access from the host side.

Therefore, there is a need in the art for improved access to the DRAM using namespace mapping.

### SUMMARY OF THE DISCLOSURE

The present disclosure generally relates to improved access to the DRAM using namespace mapping. The PMR address range is mapped to LBA address space. Mapping the PMR address range in LBA address space allows the host to access the PMR indirectly using NVMe commands. The host device may hold in the namespace the most frequently accessed data and obtain highest performance and low latency. Implementation of the Power Loss Protection (PLP) feature over the PMR makes the system prefer storing the data in PMR rather in host memory. All internal SRAMs (e.g. Transfer RAMs, XOR RAMs, etc.) may be mapped in the LBA address space so the host device can access mainly for debug purposes. Some internal flops that hold important data are mapped in the LBA address space as well.

In one embodiment, a data storage device comprises: a memory device; and a controller coupled to the memory device, wherein the controller is configured to: receive a command; parse the command; determine whether the command is mapped to the memory device; and execute the command by accessing a persistent memory region (PMR) or a controller memory buffer (CMB).

In another embodiment, a data storage device comprises: a memory device; and a controller coupled to the memory device, wherein the controller is configured to: map persistent memory region (PMR) or controller memory buffer (CMB) to a namespace (NS); receive a command from a host device to access the PMR or CMB, wherein the command is a non-volatile memory express (NVMe) command; and execute the command.

In another embodiment, a data storage device comprises: memory means; and a controller coupled to the memory means, wherein the controller is configured to: receive a non-volatile memory express (NVMe) command from a host device, wherein the command includes a logical block address (LBA), wherein the LBA is associated with a namespace (NS), wherein the NS is disposed at a memory location distinct from the memory means; and retrieve data associated with the NVMe command, wherein the memory location distinct from the memory means is a memory location is disposed in the controller and permits the host device to directly store data associated with the LBA and NS in the memory distinct from the memory means.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration using part of DRAM as PMR.

FIG. 3 is a chart illustrating using host namespace access to PMR according to one embodiment.

FIG. 4 is a flowchart illustrating using part of the DRAM as indirect access to the PMR according to another embodiment.

FIG. 5 is a schematic illustration using part of the DRAM as indirect access to the PMR according to another embodiment.

FIG. 6 is a schematic illustration of the host device having indirect access to SRAM and internal flops by mapping both the SRAM and internal flops into LBA memory space according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to improved access to the DRAM using namespace mapping. The PMR address range is mapped to LBA address space. Mapping the PMR address range in LBA address space allows the host to access the PMR indirectly using NVMe commands. The host device may hold in the namespace the most frequently accessed data and obtain highest performance and low latency. Implementation of the Power Loss Protection (PLP) feature over the PMR makes the system prefer storing the data in PMR rather in host memory. All internal SRAMs (e.g. Transfer RAMs, XOR RAMs, etc.) may be mapped in the LBA address space so the host device can access mainly for debug purposes. Some internal flops that hold important data are mapped in the LBA address space as well.

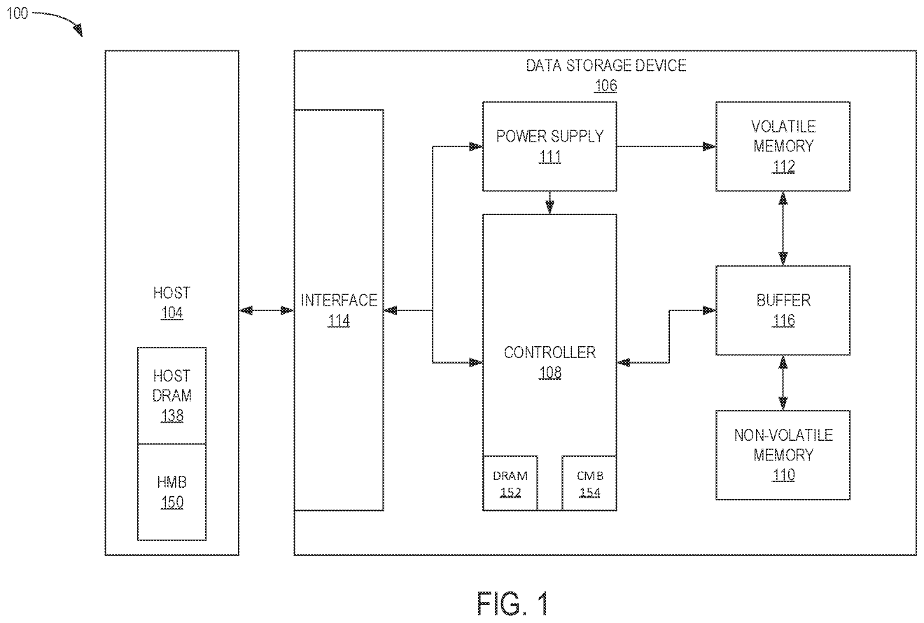

FIG. 1 is a schematic block diagram illustrating a storage system 100 in which a host device 104 is in communication with a data storage device 106, according to certain embodiments. For instance, the host device 104 may utilize a non-volatile memory (NVM) 110 included in data storage device 106 to store and retrieve data. The host device 104 comprises a host DRAM 138 and, optionally, a host memory buffer (HMB) 150. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The data storage device 106 includes a controller 108, NVM 110, a power supply 111, volatile memory 112, the interface 114, and a write buffer 116. In some examples, the data storage device 106 may include additional components not shown in FIG. 1 for the sake of clarity. The controller 108 may include volatile memory such as DRAM 152 as well as a controller memory buffer (CMB) 154 dedicated for host device 104 usage. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)).

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

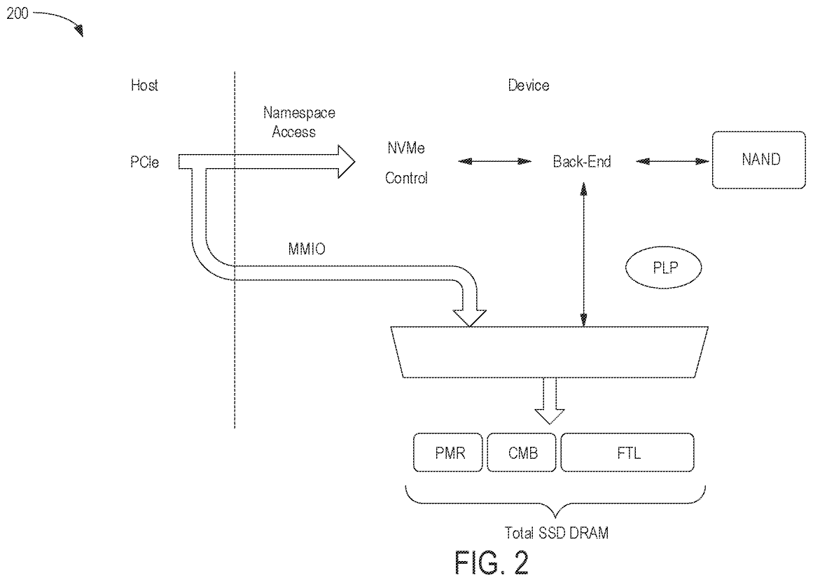

FIG. 2 is a schematic illustration 200 using part of DRAM as PMR. In addition, FIG. 2 depicts a system where part of the DRAM is used as PMR. The host device can access the PMR directly using PCIe memory read and write transactions and not indirectly using NVMe commands by namespace accesses since this region is not mapped in LBA memory space.

In client and in enterprise storage applications, the native CMB/PMR as defined today is not required. The feature complicates the device controller and makes the device controller more expensive since the inbound path (host to device) should be high-performance as the outbound path (device to host). Another item that contributes to the complexity is the byte access. Byte access applications do not need the CMB/PMR as defined today due to the above disadvantages. However, the PMR has other advantages such as low access latency and high-performance region. To have a feature without the drawback mentioned above is beneficial.

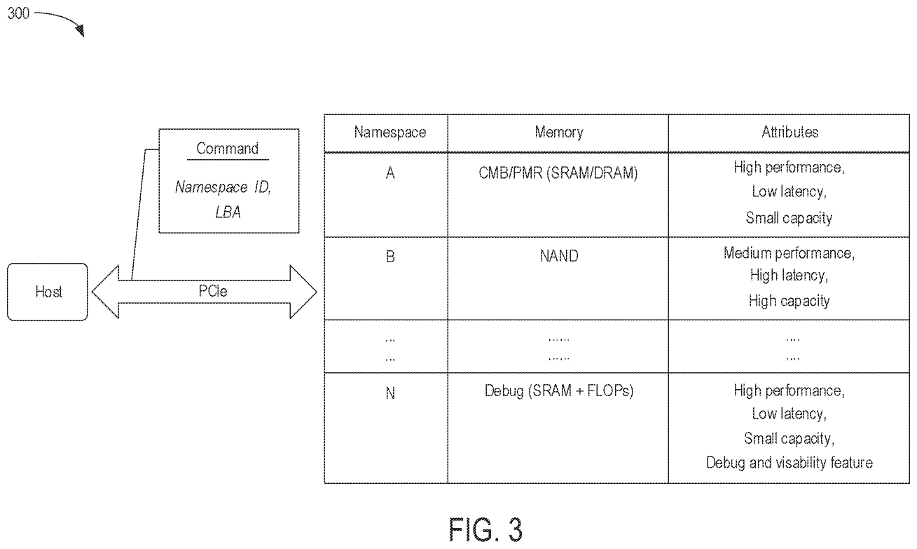

FIG. 3 is a chart 300 illustrating using host namespace access to PMR according to one embodiment. In addition, FIG. 3 depicts the high-level concept of host namespace access. The host device sends commands to the data storage device and based on the namespace ID and the LBA, the command is mapped to the relevant memory region. In the example of FIG. 3, CMB/PMR is namespace A. The namespace A is implemented either in SRAM or DRAM and therefore has high-performance, low-latency and small capacity attributes. In another example, the NAND is mapped as namespace B. The namespace B is implemented in the NAND and therefore has medium-performance, high-latency, and high-capacity. In another example, the debugging information is mapped as namespace N. The namespace N is implemented in the SRAM and flop's and therefore has high-performance, low-latency, and small-capacity, and debugging and visibility features.

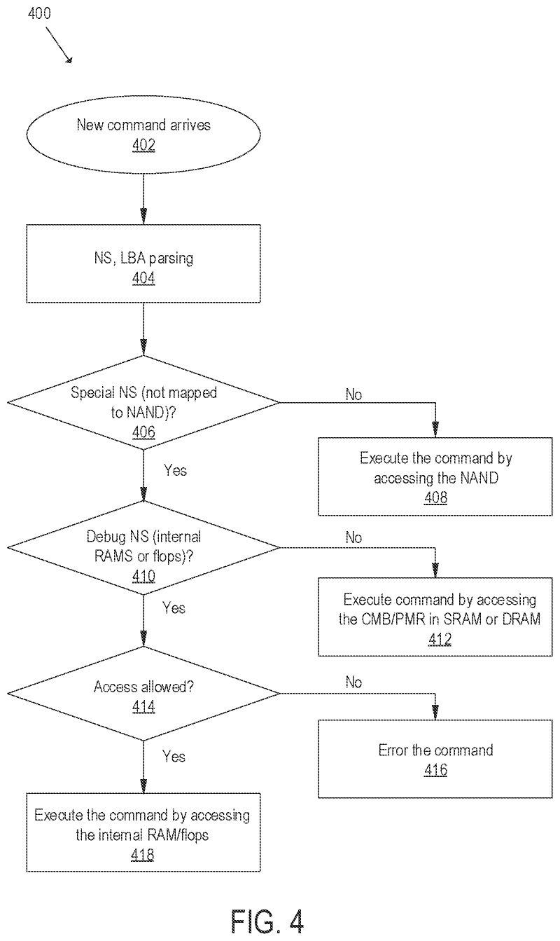

FIG. 4 is a flowchart 400 illustrating using part of the DRAM as indirect access to the PMR according to another embodiment. When a command is fetched, the namespace and LBA are parsed. When the special namespace is accessed, the security attributes are checked and only if allowed the relevant memory is implemented in either DRAM, SRAM or flops is accessed. Otherwise, the command is terminated with error status.

In operation 402, a new command arrives. In operation 404, namespace LBA parsing begins. In operation 406, the system determines whether the namespace is special (i.e., not mapped to the NAND). If the answer is no then the operation will execute the command by accessing the NAND in operation 408. If the answer is yes the process proceeds to operation 410.

In operation 410, the system determines whether the namespace is the debugging (internal RAMS or flops) namespace. If the answer is no then the operation will execute the command by accessing the CMB/PMR in SRAM or DRAM in operation 412. If the answer is yes the process proceeds to operation 414.

In operation 414, the system determines whether access is allowed. If the answer is no then the command will be tagged as an error at 416. If the answer is yes the process proceeds to operation 418. In operation 418, the system executes the command by accessing the internal RAMs/flops.

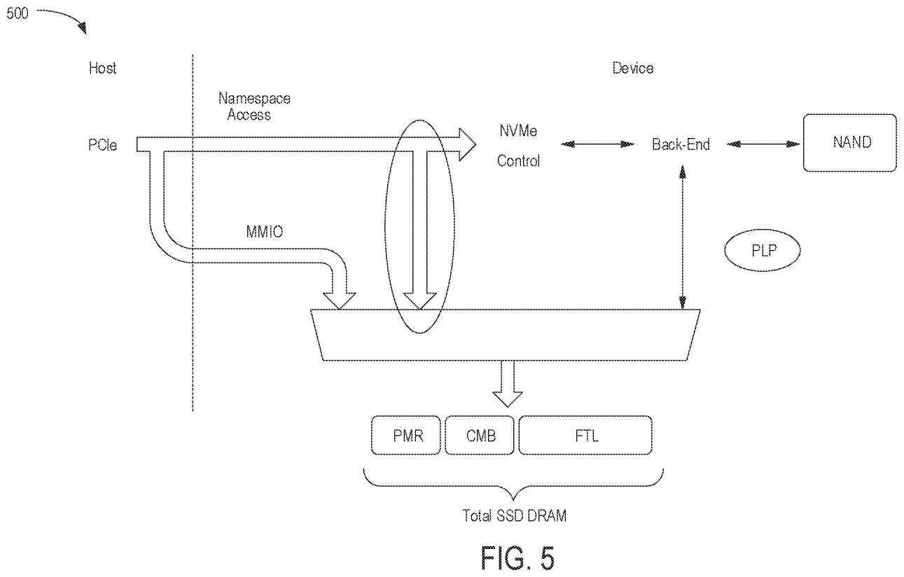

FIG. 5 is a schematic illustration 500 using part of the DRAM as indirect access to the PMR according to another embodiment. In addition, FIG. 5 depicts the same system as illustrated in FIG. 2 while highlighting the change disclosed in this embodiment. The host device may have indirect access to CMB/PMR using the NVMe commands. The indirect access can be done by mapping the CMB/PMR or even the entire DRAM in the LBA space. The accesses will have low latency and high performance since the data is stored in either SRAM or DRAM, but not in the NAND. The high performance of the PMR is achieved using already existing logic of the data storage device. The existing logic is the outbound path when the data storage device is the master of the PCIe bus. The outbound path is used in all regular 10 traffic supported by the data storage device. There is no need to add extra logic to the data storage device to support the outbound path (i.e., unlike direct access to the PMR path which uses an inbound path).

By mapping the CMB/PMR in the LBA an indirect path from the host to the CMB/PMR is created. As seen in FIG. 5 the command now passes through the namespace access into the DRAM compared to FIG. 2 where the only path to the DRAM was through the PCIe. In the instant embodiment, the command has an indirect path to the CMB/PMR located in the DRAM. It is beneficial to map the CMB/PMR in the LBA to create an indirect path to the DRAM. Since data will be stored in the DRAM, the indirect access will have low latency and high performance.

The ideal path to the DRAM is by mapping the CMB/PMR in the LBA. The cost savings and increased performance are seen in the new approach. Storing data in the CMB/PMR is preferable to the host memory since the CMB/PMR implements the PLP. Data loss is then decreased when the most frequent accesses are helped in the mapped CMB/PMR namespaces in the LBA.

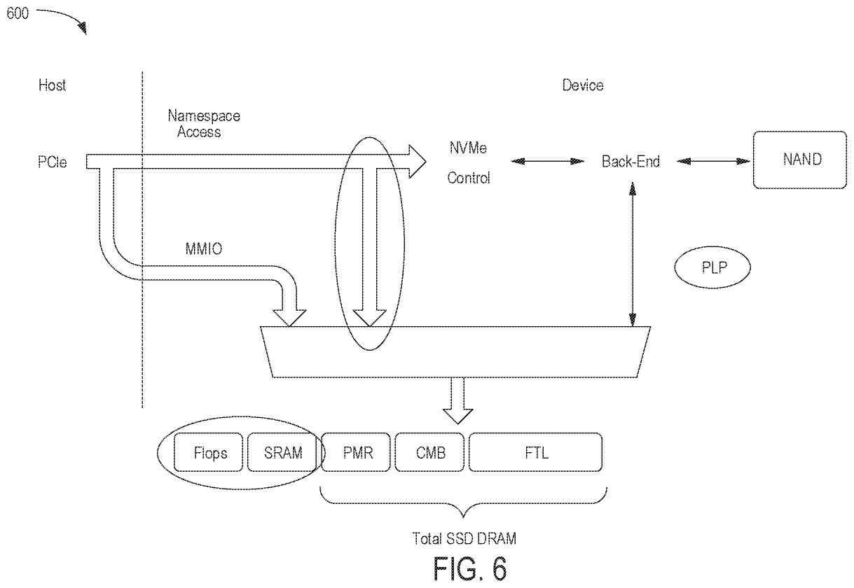

FIG. 6 is a schematic illustration 600 giving the host device indirect access to SRAM and internal flops by mapping both the SRAM and internal flops into LBA memory space according to one embodiment. In addition, FIG. 6 depicts all internal RAMs and even some important flops are also mapped in LBA memory space. The host device will be able to access the data using namespace access by NVMe commands. The feature increases visibility and reduces the time-to-market since it simplifies the debug process.

Improved access to the DRAM using namespace mapping can be achieved and provides numerous advantages including performance, visibility, and TTM. The data storage device can allocate a performance zone to the host device and the host device could use the zone for caching and LBAs that are accessed frequently. The zone can be implemented in SRAM or DRAM so that access latency is very short and performance is very high. On the other hand, the size of the zone is relatively small. The data storage device also implements the power loss protection (PLP) over the zone so that the data will not be lost during a power failure event. Additionally, all internal SRAM could be mapped into the area so that the host device will be able to access the memory within the data storage device using NVMe commands which can be very useful in debug scenarios.

In one embodiment, a data storage device comprises: a memory device; and a controller coupled to the memory device, wherein the controller is configured to: receive a command; parse the command; determine whether the command is mapped to the memory device; and execute the command by accessing a persistent memory region (PMR) or a controller memory buffer (CMB). The command comprises a logical block address (LBA). The LBA is mapped to a namespace (NS), and wherein the NS is not mapped to the memory device. The controller is further configured to allocate a namespace (NS) for debugging. Internal databases of the controller are mapped to the NS. Internal databases include flash translation tables (FTLs), SRAM databases, and FLOPs. The controller is further configured to: determine whether the command corresponds to a namespace (NS) mapped to the memory device; and determine whether the NS is a debug NS. The controller is further configured to allow access to the debug NS. The debug NS is not mapped to the memory device and allowing access comprises retrieving data and providing the data to a host device. Executing the command comprises accessing the PMR or CMB and providing data associated with the command to a host device.

In another embodiment, a data storage device comprises: a memory device; and a controller coupled to the memory device, wherein the controller is configured to: map persistent memory region (PMR) or controller memory buffer (CMB) to a namespace (NS); receive a command from a host device to access the PMR or CMB, wherein the command is a non-volatile memory express (NVMe) command; and execute the command. Executing the command comprises retrieving data from the PMR or CMB and providing the data to the host device. The NS is disposed in a location separate from the memory device. The NS comprises debug information. The controller comprises power loss protection (PLP). The command comprises a logical block address (LBA). The controller additionally is configured to map debug information to a second NS, wherein the debug information is disposed in a location distinct from the memory device.

In another embodiment, a data storage device comprises: memory means; and a controller coupled to the memory means, wherein the controller is configured to: receive a non-volatile memory express (NVMe) command from a host device, wherein the command includes a logical block address (LBA), wherein the LBA is associated with a namespace (NS), wherein the NS is disposed at a memory location distinct from the memory means; and retrieve data associated with the NVMe command, wherein the memory location distinct from the memory means is a memory location is disposed in the controller and permits the host device to directly store data associated with the LBA and NS in the memory distinct from the memory means. The memory distinct from the memory means comprises FLOPs, static random access memory (SRAM), persistent memory region (PMR), controller memory buffer (CMB), or flash translation layer (FTL). The memory distinct from the memory means is mapped in LBA memory space.

The device is able to map CMB/PMR, SRAM, and flops to the name space of the LBA for an indirect path to the DRAM. The device can allocate a performance zone to the host. The host can use the zone for caching and LBAs that are accessed frequently. The zone is implemented in SRAM or DRAM so access latency is very short and performance is very high. While the space is small, the device can also implement the PLP over the zone so the data will not be lost during power failure. All of the internal SRAM can be mapped into this area so the host will be able to access the memory within the device using NVMe commands. This is very useful in debugging scenarios.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
receive a command;
parse the command;
determine whether the command is mapped to the memory device; and
execute the command by accessing a persistent memory region (PMR) or a controller memory buffer (CMB).

2. The data storage device of claim 1, wherein the command comprises a logical block address (LBA).

3. The data storage device of claim 2, wherein the LBA is mapped to a namespace (NS), and wherein the NS is not mapped to the memory device.

4. The data storage device of claim 1, wherein the controller is further configured to allocate a namespace (NS) for debugging.

5. The data storage device of claim 4, wherein internal databases of the controller are mapped to the NS.

6. The data storage device of claim 5, wherein internal databases include flash translation tables (FTLs), SRAM databases, and FLOPs.

7. The data storage device of claim 1, wherein the controller is further configured to:
determine whether the command corresponds to a namespace (NS) mapped to the memory device; and
determine whether the NS is a debug NS.

8. The data storage device of claim 7, wherein the controller is further configured to allow access to the debug NS.

9. The data storage device of claim 8, wherein the debug NS is not mapped to the memory device and allowing access comprises retrieving data and providing the data to a host device.

10. The data storage device of claim 1, wherein executing the command comprises accessing the PMR or CMB and providing data associated with the command to a host device.

11. A data storage device, comprising:
a memory device; and
a controller coupled to the memory device, wherein the controller is configured to:
map persistent memory region (PMR) or controller memory buffer (CMB) to a namespace (NS);
receive a command from a host device to access the PMR or CMB, wherein the command is a non-volatile memory express (NVMe) command; and
execute the command.

12. The data storage device of claim 11, wherein executing the command comprises retrieving data from the PMR or CMB and providing the data to the host device.

13. The data storage device of claim 11, wherein the NS is disposed in a location separate from the memory device.

14. The data storage device of claim 13, wherein the NS comprises debug information.

15. The data storage device of claim 11, wherein the controller comprises power loss protection (PLP).

16. The data storage device of claim 11, wherein the command comprises a logical block address (LBA).

17. The data storage device of claim 16, wherein the controller additionally is configured to map debug information to a second NS, wherein the debug information is disposed in a location distinct from the memory device.

18. A data storage device, comprising:
memory means; and
a controller coupled to the memory means, wherein the controller is configured to:
receive a non-volatile memory express (NVMe) command from a host device, wherein the command includes a logical block address (LBA), wherein the LBA is associated with a namespace (NS), wherein the NS is disposed at a memory location distinct from the memory means; and
retrieve data associated with the NVMe command, wherein the memory location distinct from the memory means is a memory location is disposed in the controller and permits the host device to directly store data associated with the LBA and NS in the memory distinct from the memory means.

19. The data storage device of claim 18, wherein the memory distinct from the memory means comprises FLOPs, static random access memory (SRAM), persistent memory region (PMR), controller memory buffer (CMB), or flash translation layer (FTL).

20. The data storage device of claim 19, wherein the memory distinct from the memory means is mapped in LBA memory space.
